(19) United States
(12) Patent Application Publication
(10) Pub. No.: US 2010/0132166 A1
(43) Pub. Date: Jun. 3, 2010

(54) Adjustable cable locking mechanism for truck doors

(76) Inventor: Jason Z. Vargas, Manteca, CA (US)

Correspondence Address: ZIMMERMAN & CRONEN, LLP, 1330 BROADWAY, SUITE 710, OAKLAND, CA, 94612-2506, US

(21) Appl. No.: 12/315,346

(22) Filed: Dec. 1, 2008

(51) Int. Cl. F16G 11/06; F16G 11/14; A44B 13/00; B25B 5/10

(52) U.S. Cl. 24/135 R; 24/115 H; 24/592.1; 269/249

(57) ABSTRACT

A tie-down assembly to hold cargo box doors in an open position includes a pair of clamping blocks, each having a pair of passages extending therethrough in adjacent fashion. A wire rope includes a first end that is extended through a first passage of one block and thence into the adjacent opening of the second passage of the same block, so that it forms a wire rope loop at one end of each block. At the other end of the block the wire rope extends to the other clamping block and is received in the first passage of the other block, thence forming a loop and extending into the adjacent opening of the second passage of the other block. A thumbscrew is arranged to releasably engage the wire rope extending through the first passage, whereby the wire rope may be removed from the first passage, or slidably moved in the first passage to adjust the size of the wire loop. The wire rope is fixedly secured in the second passage of each clamping block. One wire loop is releasably secured about a structural feature of a cargo box door, and the other wire loop is releasably secured to a structural feature of the cargo box itself, whereby the cargo door may be held temporarily in an open position adjacent to the rear portion of a sidewall of the cargo box.

### CROSS-REFERENCE TO RELATED APPLICATIONS

Not applicable

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to an adjustable tie-down mechanism for cargo doors and, more particularly, to an adjustable tie-down that is adaptable to a wide variety of cargo door arrangements.

2. Description of Related Art

Cargo boxes now in use on tractor trailers are usually provided with a pair of rear cargo doors that are vertically hinged at the sides of the trailer and adapted to be rotated to meet in the middle of the open end of the trailer, whereby the open end may be closed and sealed for transport and security, and opened for loading, unloading, and inspection of the cargo. When the doors are swung fully open the access opening is virtually equal to the box cross-section. After the cargo has been loaded the doors are swung to the closed position and each is latched shut by imparting rotation to a vertical latch bar to cause upper and lower latch bar ends to lock in keepers fixed in the door frame. Cargo containers are often provided with similar doors and latching arrangements.

For a truck driver who is picking up or delivering an order, it is generally necessary to drive to the appointed place for the pickup or delivery, ascertain the location and layout of the truck loading dock, and prepare the trailer for the loading or unloading operation. Generally, the lateral space at a loading dock is at a premium, and there is not sufficient space for the cargo doors to be rotated to the fully open position in which the doors are adjacent to the side walls of the trailer. This configuration is typically necessary to enable two or more trailers to be parked side-by-side at the loading dock, and opening the cargo doors after backing into the loading dock would necessarily cause the doors to interfere with the adjacent trailers.

Thus it is often necessary for a trucker to open the cargo doors before approaching the loading dock, and it is equally necessary to assure that the opened doors are held in the fully open position. The prior art is deficient in providing devices that carry out this particular task. Although tie-downs of various sorts are available in the prior art, they do not address this particular need.

### BRIEF SUMMARY OF THE INVENTION

The present invention generally comprises a tie-down assembly that is designed to hold tractor trailer cargo doors in the open position when the trailer is moved into position at a loading dock, and which can be operated and released with a minimum of effort and time.

In one aspect, the invention includes a pair of clamping blocks, each having a pair of passages extending therethrough in adjacent fashion. A wire rope includes a first end that is extended through a first passage of one block and thence into the adjacent opening of the second passage of the same block, so that it forms a wire rope loop at one end of each block. At the other end of the block the wire rope extends to the other clamping block and is received in the first passage of the other block, thence forming a loop and extending into the adjacent opening of the second passage of the other block. Thus each clamping block supports a wire rope loop at a distal end, and the proximal ends of the clamping blocks are joined in confronting relationship by the wire rope.

In each block, there is a thumbscrew located in a threaded hole that is located adjacent to the first passage. The thumbscrew is arranged to releasably engage the wire rope extending through the first passage, whereby the wire rope may be removed from the first passage, or slidably moved in the first passage to adjust the size of the wire loop. The wire rope is fixedly secured in the second passage of each clamping block, so that the two clamping blocks are held in a fixed distance each from the other.

One wire loop may be releasably secured about a structural feature of a cargo box door, and the other wire loop may be releasably secured to a structural feature of the cargo box itself, whereby the cargo door may be held temporarily in an open position adjacent to the rear portion of a sidewall of the cargo box. This arrangement enables the truck driver to open the cargo doors and tie them down in the open position prior to backing up to a loading dock. The wire loop may be snared on any structural feature of the cargo door or cargo box or truck frame, or a wire loop may be opened by releasing its respective thumbscrew, so that the free wire end of the loop may be passed through a convenient opening in the cargo door or trailer structure. The wire end is then fed through its respective first passage to recreate the wire loop, and pulled tight before tightening the thumbscrew to hold tightly to the opening that is serving as an anchor for the device.

In addition, the invention may provide an S hook and/or a C-clamp secured to at least one wire loop to engage a structural feature of the cargo door or cargo trailer. The hook or clamp enables the device to be joined to a structure that may not present a convenient way to snare the wire loop or pass the wire through to form a tight loop. The S hook may be closed onto one of the wire loops so that it is slidable on the wire rope of the loop but otherwise retained thereon.

It is noted that both the clamping blocks are identical in construction, so that there is an economy of simplicity in the construction of the tie-down. Furthermore, a single continuous length of wire rope is sufficient to form the wire loops and the connection between the clamping blocks. The fixation of the wire rope in the second passage of each clamping block may be accomplished by applying sufficient force to each clamping block in the area of the second passage to crimp the second passage onto the wire rope and prevent any movement of the wire rope through the second passage.

The cargo door tie-down assembly is easily installed and removed, taking only a few seconds to accomplish either task. When not in use, the cargo door tie-down is sufficiently small and light to be carried by the truck driver to each job or delivery, or may be secured to a structural feature of the truck body or cargo doors, either as a means of keeping the tie-down handy for future use, or for use as a secondary latch of the cargo doors for safety purposes.

### BRIEF DESCRIPTION OF THE DRAWING

FIG. 1 is a rear elevation of a typical cargo door arrangement known in the prior art.

FIG. 2 is a plan view of the cargo door tie-down of the present invention.

FIG. 3 is an end view of the clamping block portion of the cargo door tie-down of the present invention.

FIG. 4 is a cross-sectional elevation of the clamping block shown in FIG. 3.

FIG. 5 is a perspective view of a typical use of the cargo door tie-down of the invention.

FIG. 6 is a perspective view of another typical use of the cargo door tie-down of the invention.

FIG. 7 is a plan view showing a portion of the cargo door tie-down with an S hook feature.

FIG. 8 is a view similar to FIG. 7 showing the use of a C-clamp assembled to the cargo door tie-down.

FIG. 9 is a perspective view of the invention in use with a C-clamp to secure a cargo door to a cargo box.

### DETAILED DESCRIPTION OF THE INVENTION

The present invention generally comprises a tie-down assembly that is designed to hold tractor trailer cargo doors in fully open position when the trailer is moved into position at a loading dock.

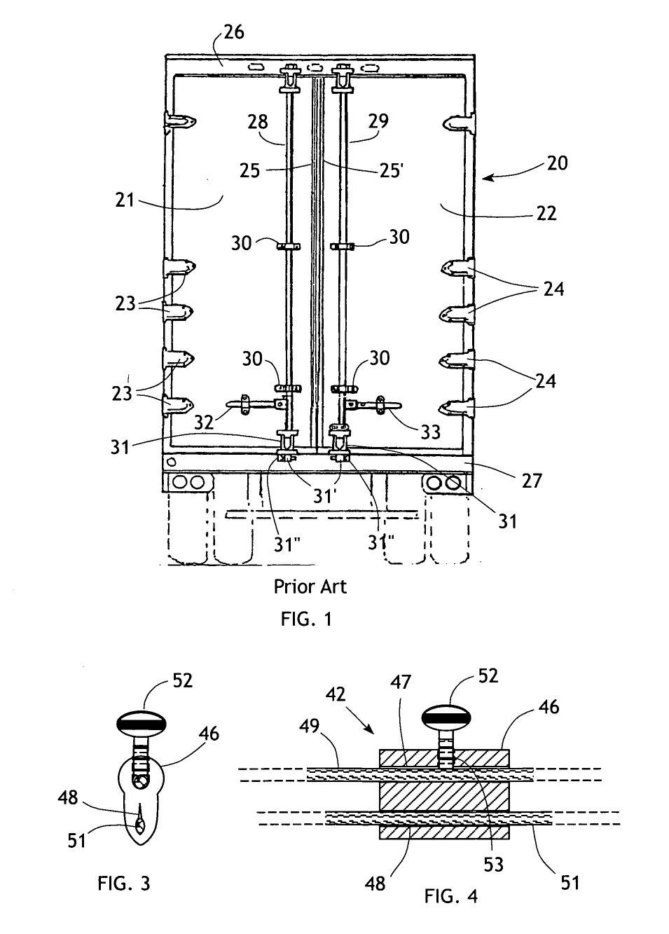

With regard to FIG. 1, a typical cargo box door arrangement includes a cargo box 20 provided with left and right rear doors 21, 22 hingedly carried on frame-mounted sets of vertical-axis hinges 23, 24 and meeting along their inner vertical margins 25, 25′. Such doors generally extend slightly below the box floor level (not shown) and engage the lower margin of upper box frame 26 and the upper margin of lower box frame 27. Each door is provided with a latch bar, respectively designated 28, 29, rotatable in sets of vertically-spaced journals 30 intermediate their vertical extent, and are further journalled in upper and lower door-mounted bearings 31.

The extremities of each latch bar are conventionally fitted with a latch foot 31′ that engages frame-mounted keepers 31″, the connection being made by imparting rotation to the latch bar by means of respective lever arms 32, 33 when these are brought closely adjacent the doors 21, 22. The latches may include cam-like elements or lugs that lock into recesses in the keepers to secure the latch bars in the keepers 31″ and keep the cargo doors 21 and 22 fully closed. To open the doors the holders that maintain the arms 32, 33 contiguous to their respective doors are released, and each arm is swung outwardly through an angle usually less than 45° to release the latch foot at each end of the latch bar, whereby the doors may be pivoted to the open position. These elements or their equivalents are generally well-known in the prior art, and are familiar to truck drivers and loading dock workers.

Note that the hinges 23 and 24 are mounted at the vertices of the rear end portions of the sidewalls of the cargo box, so that the doors 21 and 22 may be rotated open to a maximum extent in which the doors are substantially flush with the rear end portions of the sidewalls, so that the open cargo box is not much wider than when it is closed and latched, whereby the cargo box occupies a minimal lateral dimension when moved up to a loading dock. As noted above, it is often necessary for a truck driver to open the cargo doors before approaching a loading dock, and it is equally necessary to assure that the opened doors are held in the fully open position, so that the doors do not occupy dock space that may be required for other truck cargo boxes parked adjacent to the box 20.

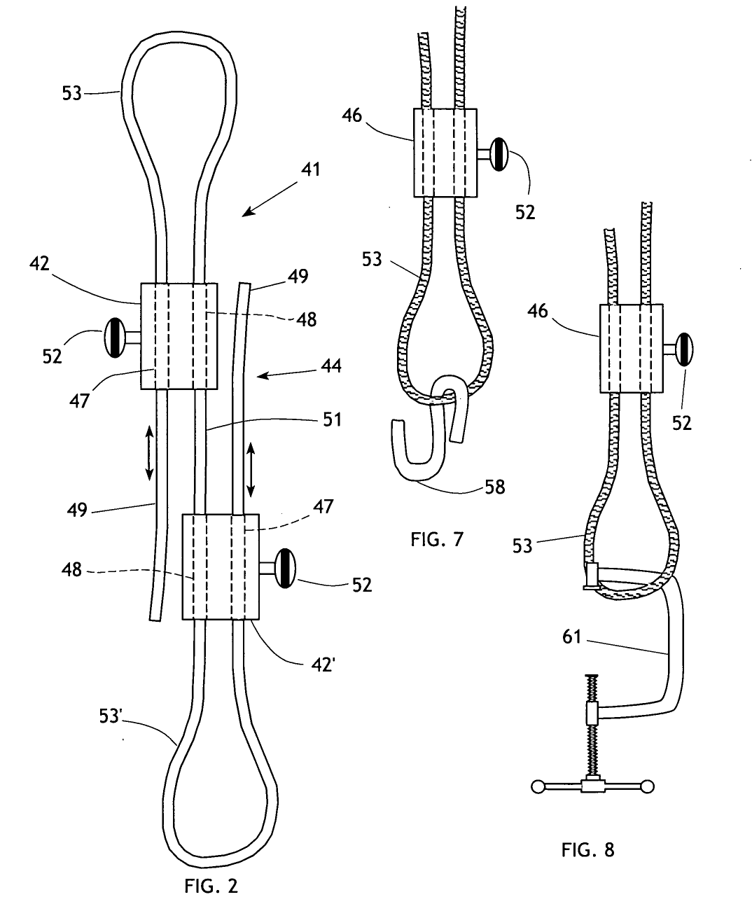

With regard to FIGS. 2-4, the basic components of the tie-down assembly 41 of the invention include a pair of clamping blocks 42 and 42′, generally identical in construction, and a length of wire rope 44. Each clamping block (generically referred to as 42) includes a body 46 having a pair of passages 47 and 48 extending therethrough to receive the wire rope 44. That is, one portion 49 of the wire rope extends through passage 47, and another portion 51 of the wire rope extends through passage 48. A thumbscrew 52 is received in a threaded hole that intersects the passage 47, so that the portion 49 may be releasably secured in the passage 47.

The passages 47 and 48 extend generally parallel through the body 46, though the passages may be aligned in any convenient arrangement. As shown particularly in FIG. 3, the portion of the body 46 surrounding the passage 48 is crimped to collapse the passage 48 onto the wire rope portion 51, immobilizing the portion 51 in the passageway. Other means for securing the portion 51 may be employed, including adhesives, welding, or the like.

With particular reference to FIG. 2, the wire rope portion 51 that extends from the passage 48 of clamping block 42 also passes through the passage 48 of clamping block 42′, whereby the two clamping blocks 42, 42′ are held at a fixed distance by the portion 51. At the opposed outer ends of the clamping blocks, the portion 51 exits from the passage 48 and is formed into a loop 53, 53′ (generically, 53) and then passes into the opening of the passage 47 at the respective opposed end to define portion 49 of the wire rope, and extends through the passage 47 to exit therefrom. Note that the thumbscrew 52, 52′ releasably secures the portion 49, thus enabling the adjustment of the size of the loop 53 or the complete removal of the portion 49 from the passage 47, for purposes to be described below.

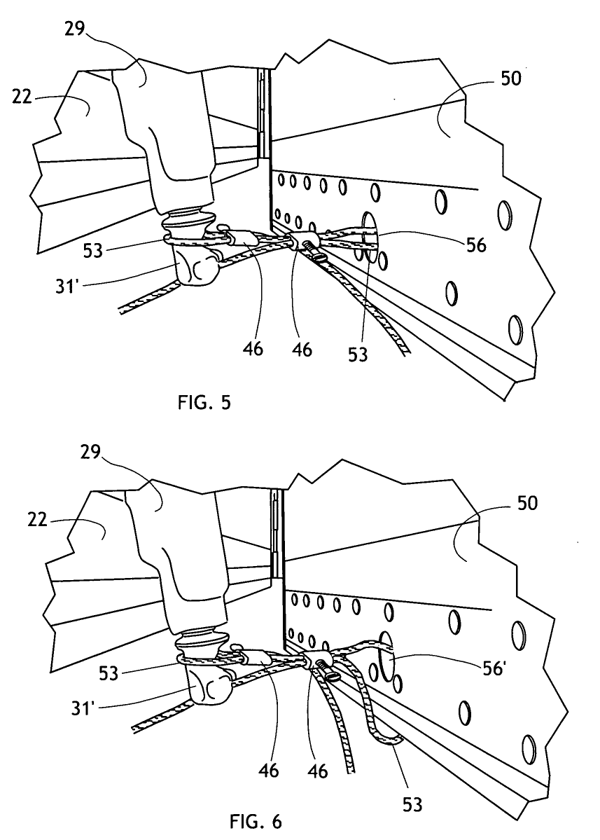

One wire loop 53 may be releasably secured about a structural feature of a cargo box door, and the other wire loop 53 may be releasably secured to a structural feature of the cargo box itself, whereby the cargo door may be held temporarily in an open position adjacent to the rear portion of a sidewall exterior of the cargo box. For example, as shown in FIG. 5, a cargo door 22 of a cargo box 20 may be opened substantially completely, so that the door 22 is adjacent to the rear exterior portion of the sidewall 50 of the cargo box 20. The latch foot 31′ of latch bar 29 extends downwardly from the lower edge of the door 22, and comprises a useful structural feature for the purposes of the invention. One loop 53 may be secured about the foot 31′ and tightened by loosening the respective thumbscrew 52, pulling the wire rope portion 49 through passage 47 to tighten the loop on the foot 31′, then re-tightening the thumbscrew. The other loop 53 may be secured similarly to a tie-down hook typically provided on a cargo box side frame member within hole 56, and tightened in similar manner. This process requires only a few seconds of effort, and prevents the door 22 from rotating on it hinges, whereby it is kept in the fully open disposition. Removing the invention from its temporary mounting also requires only a few seconds to accomplish. The other cargo door 21 may be temporarily secured in similar fashion by another tie-down assembly of the invention, and similarly released after cargo loading or unloading.

Referring to FIG. 6, some cargo boxes on freight trailers are provided with holes 56′ that are not equipped with a hook, but rather merely extend through the frame to provide a different form of tie-down opportunity. In this case, the loop 53 that engages the cargo box frame is opened entirely by loosening the respective thumbscrew 52 and passing the free end of wire rope portion 49 through the hole 56′, about the frame member, and back into the clamping body 46, where it is tightened as before. This process requires no more time than the previous example, and achieves the same results. It may be appreciated that most truck bodies and cargo boxes are provided with multiple structural features that may be used and exploited to carry out the purpose of the tie-down of the invention.

With regard to FIG. 7, the tie-down assembly of the invention may be augmented by the provision of a hook 58 secured to one of the loops 53. In this example the hook 58 has an S-shape, and one half of the S is crimped or collapsed onto the wire rope of loop 53 so that it cannot accidentally fall from the loop. The hook 58 enables the tie-down to be engaged with any protrusion, edge, or prominence on the cargo box or frame that is conveniently located with respect to the open cargo door. Likewise, a clamping device (any type known in the prior art) may be used in conjunction with the tie-down 44 to enable the tie-down to be engaged with a structural component of the cargo door or cargo box or frame.

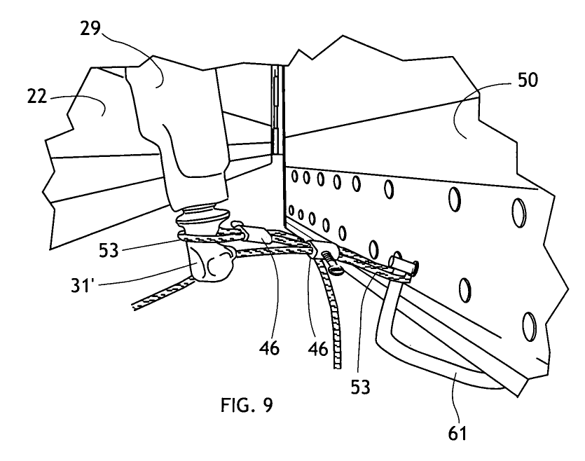

Although the tie-down 44 has been described with reference to its use engaging the foot of a cargo door latch bar, there are many other structural features on a typical cargo door that may be use to releasably secure the tie-down for the purposes described above. This adaptability is made more manifest by the provision of the hook 58, as shown in FIG. 7, that may be used to link the loop 53 to a structural member of the cargo hauler. In addition, the tie-down 44 may be used for other door configurations, such as sliding cargo doors or overhead doors, for the purposes described herein. For uses with some cargo boxes, such as seagoing cargo containers, that lack openings or convenient structural features that can be looped or hooked, the invention may be used with a C-clamp 61, as shown in FIG. 8. The clamp 61 is easily joined to structural features of the cargo box that are too large to be hooked or too broad to be snared by loop 53, and is easily removed as well. For example, as shown in FIG. 9, the clamp 61 may be secured to the lower edge of the cargo box body when there is no available structural feature to be hooked or snared with a loop, or the clamp may be secured to the frame beneath the box or any other susceptible feature.

The wire rope may comprise in the preferred embodiment a ⅛×25 galvanized rope that is vinyl coated, and the clamping body 46 may be formed of lightweight aluminum. Thus the tie-down assembly 44 is surprisingly light and compact for a device that provides so much functionality, and may be carried by the truck driver from job to job with ease. Consequently it is not necessary to secure the tie-down to the exterior of the cargo hauler during transport or storage of the cargo hauler, so it is not subject to theft, damage, malicious mischief, or exposure to the elements.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. An adjustable tie-down mechanism for cargo box doors, including:
a pair of clamping blocks, each having first and second passages extending therethrough;
a wire rope having a first end that is slidably extended through a first passage of one of said clamping blocks and thence into the adjacent opening of the second passage of said one clamping block to form a first wire loop, and a second end that is slidably extended through a first passage of the other of said clamping blocks and thence into the adjacent opening of the second passage of said other clamping block to form a second wire loop;
means for releasably securing said wire rope in said first passage of each of said clamping blocks, whereby said wire loops may be adjusted in length;
means for fixedly securing said wire rope in said second passage of each of said clamping blocks, whereby said pair of clamping blocks and said wire rope are permanently joined to form said mechanism.

2. The adjustable tie-down mechanism of claim 1, wherein said means for releasably securing said wire rope includes a thumbscrew disposed to impinge on said wire rope in said first passage of each of said clamping blocks.

3. The adjustable tie-down mechanism of claim 1, wherein said means for fixedly securing said wire rope includes a crimp applied to a portion of said clamping block surrounding said second passage of each of said clamping blocks.

4. The adjustable tie-down mechanism of claim 1, wherein said clamping blocks include mutually confronting ends and opposed outer ends, and said wire loops each extend from one of said opposed outer ends of said clamping blocks.

5. The adjustable tie-down mechanism of claim 1, wherein said wire loops are adapted to be releasably secured about structural features of a cargo box and cargo box door to secure the cargo box door in an open disposition.

6. The adjustable tie-down mechanism of claim 1, further including a hook secured to one of said wire loops and adapted to engage a structural feature of a cargo box or a cargo box door.

7. The adjustable tie-down mechanism of claim 1, further including a C-clamp secured to one of said wire loops and adapted to engage a structural feature of a cargo box or a cargo box door.

8. An adjustable tie-down mechanism for cargo box doors, including:
a pair of clamping blocks and means for joining said clamping blocks together in permanent, spaced apart relationship;
a pair of wire loops, each extending from a respective one of said clamping blocks;
means for releasably securing said pair of wire loops to engage a structural feature of a cargo box and a door hinged to the cargo box, whereby the cargo box door is maintained in an open disposition.

9. The adjustable tie-down mechanism of claim 8, wherein said pair of wire loops are formed of a single piece of wire rope.

10. The adjustable tie-down mechanism of claim 9, wherein said means for joining said clamping blocks permanently also comprises said single piece of wire rope.

11. The adjustable tie-down mechanism of claim 8, further including means for adjusting the size of each of said wire loops, whereby said wire loops may be tightened about a structural feature of a cargo box and a cargo box door to temporarily secure said mechanism therebetween.

12. The adjustable tie-down mechanism of claim 11, wherein said means for adjusting includes a first passage extending through each of said clamping blocks and receiving a wire loop portion therethrough, and a thumbscrew secured in each of said clamping blocks and disposed to releasably secure said wire loop portion in said first passage.

13. The adjustable tie-down mechanism of claim 12, wherein said means for joining said clamping blocks permanently includes a second passage extending through each of said clamping blocks and receiving another wire loop portion therethrough, and a crimp applied to a portion of each of said clamping blocks surrounding said second passage of said clamping blocks.

14. The adjustable tie-down mechanism of claim 8, further including a hook secured to one of said wire loops and adapted to engage a structural feature of a cargo box or a cargo box door.

15. The adjustable tie-down mechanism of claim 18, further including a C-clamp secured to one of said wire loops and adapted to engage a structural feature of a cargo box or a cargo box door.

16. An adjustable tie-down mechanism for cargo box doors, including:
at least one clamping block;
a pair of wire loops, each extending from said at least one clamping block;
means for releasably securing said pair of wire loops to engage a structural feature of a cargo box and a door hinged to the cargo box, whereby the cargo box door is maintained in an open disposition.

17. The adjustable tie-down mechanism of claim 16, wherein said pair of wire loops are formed of a single piece of wire rope extending through said at least one clamping block.

18. The adjustable tie-down mechanism of claim 16, wherein said means for releasably securing said pair of wire loops includes at least one thumbscrew secured to said at least one clamping block and disposed to impinge on said single piece of wire rope as it extends through said at least one clamping block.
